(19) United States
(12) Patent Application Publication
(10) Pub. No.: US 2024/0206409 A1
(43) Pub. Date: Jun. 27, 2024

(54) IRRIGATION SYSTEM IN AGRICULTURAL ENVIRONMENT

(71) Applicant: Indigo Ag, Inc., Charlestown, MA (US)

(72) Inventors: Yuanshuo Qu, Wakefield, MA (US); Jyoti Shankar, Jersey City, NJ (US); Richard L. Atwill, Little Rock, AR (US); Kirk A. Zmijewski, Malden, MA (US)

(21) Appl. No.: 18/391,335

(22) Filed: Dec. 20, 2023

Related U.S. Application Data
(60) Provisional application No. 63/434,204, filed on Dec. 21, 2022.
(60) Provisional application No. 63/594,324, filed on Oct. 30, 2023.

(51) Int. Cl. A01G 25/16; G05B 19/042

(52) U.S. Cl. CPC A01G 25/165; G05B 19/0426; G05B 2219/2625

(57) ABSTRACT

Irrigation systems in agricultural contexts are described herein. Specifically, temperature data is measured using temperature sensors installed above a minimum waterline and below a maximum waterline. Water pump activity data is measured based on water flow outputs from water pumps on a field. Irrigation events are detected and managed using the temperature data and the water pump activity data. Future irrigation events can be implemented, modified, or changed based on detected irrigation events.

### CROSS REFERENCE TO RELATED APPLICATIONS

This application claims the benefit of U.S. Provisional Application No. 63/434,204, filed Dec. 21, 2022, and U.S. Provisional Application No. 63/594,324, filed Oct. 30, 2023, which are incorporated by reference in their entirety.

### BACKGROUND

To maintain various sustainability records, farmers track when a field is irrigated, how long the irrigation event lasts, and how much water flows onto the field. Each irrigation event, i.e., time range when water is actively flowing through a pipe onto a field, is recorded. The recorded irrigation events are key inputs for calculating the total time during which water flowed onto the field, from which a total volume of water over a season can be determined. Farmers and analysts can use expensive sensors equipped with telemetry that report on a vibration of a water pump. When pumps (or wells) are turned on, the sensors on the surface of the pumps (or wells) detect vibration and are able to relay back through telemetry that an irrigation event has occurred. Alternatively, water monitoring can be done using a manual log for each irrigation event. Each method has limitations: in the first method, the cost can be prohibitive; and in the second method, time spent logging and reviewing manual data recordation can be monumental.

### SUMMARY

Irrigation within a field can be monitored and managed (for instance, to achieve a target ecosystem goal, to realize a target ecosystem attribute profile, or to perform an ecosystem action) using an irrigation system and a set of sensors deployed at or around the field. For instance, first temperature data can be received from a first temperature sensor deployed at a crop field, affixed or otherwise located above a minimum waterline and below a maximum waterline of the field. The first temperature data can include a plurality of temperature readings taken over a first time period. Second temperature data can be received from a second temperature sensor located at, adjacent to, or remote from the field, and represents measurements of ambient air temperature at the field. The irrigation system detects an irrigation event based on the first temperature data and the second temperature data. The irrigation system can initiate, modify, or otherwise change one or more pre-planned irrigation events or one or more unplanned irrigation events based on the detected irrigation events.

The irrigation system can include a remote server, a set of remote temperature sensors, an irrigation system (such as one or more water pumps, flow measurement systems, and the like), and an ambient temperature sensor, all communicatively coupled via a network. In some embodiments, the irrigation system can train one or more machine-learned models to detect irrigation events based on training data that includes one or more of historic field temperature data (from a particular field or a set of fields that may or may not have characteristics in common), historic ambient temperature data, historic water pump data, historic irrigation or irrigation event data, historic field image data, and the like. In some embodiments, the irrigation system can access and apply a machine-learned model to current temperature data (such as field temperature data received from remote temperature sensors located at the field as described above and herein), and can identify irrigation events. In some embodiments, irrigation events can be identified in real-time, and the irrigation system can modify the irrigation events detected in real-time. In other embodiments, the irrigation system can add additional irrigation events to an irrigation event plan or schedule, or can remove pre-planned or pre-scheduled events in response to detecting current or previous irrigation events.

### BRIEF DESCRIPTION OF THE DRAWINGS

The accompanying drawings, which are incorporated into and constitute a part of this specification, illustrate various exemplary embodiments and together with the description, serve to explain the principles of the disclosed embodiments.

FIG. 1 is a flowchart illustrating an exemplary method of monitoring irrigation events, according to techniques described herein.

FIG. 2 is a flowchart illustrating an exemplary method of training an irrigation model, according to techniques described herein.

FIG. 3 is a graphic illustrating different water levels and water level fluctuation throughout the growing season.

FIG. 4A is a graph showing the vibration data measured at a riser containing a water pump over the growing season.

FIG. 4B is a graph showing the temperature sensor data over the growing season.

FIG. 4C is a graph showing the temperature correlation between the temperature sensor data and the (flip sensor) data over the growing season.

FIG. 5 is a picture of a temperature sensor deployed in a crop field, according to techniques described herein.

FIGS. 6A-D is a series of graphs comparing temperature sensor readings to vibration sensor readings at a field over a growing season.

FIG. 6E are graphs showing the interpretability of temperature sensors deployed across a number of fields, according to techniques described herein.

FIG. 6F is a graph showing an exemplary linear regression to find a temperature counterfactual, according to techniques described herein.

FIG. 7 is a computing node according to embodiments of the present disclosure.

FIG. 8 illustrates an example system environment, according to the principles described herein.

FIG. 9 is a flowchart illustrated an exemplary method of training an irrigation model, according to the techniques described herein.

### DETAILED DESCRIPTION

Reference will now be made in detail to the exemplary embodiments of the present disclosure, examples of which are illustrated in the accompanying drawings. Wherever possible, the same reference numbers will be used throughout the drawings to refer to the same or like parts.

The systems, devices, and methods disclosed herein are described in detail by way of examples and with reference to the figures. The examples discussed herein are examples only and are provided to assist in the explanation of the apparatuses, devices, systems, and methods described herein. None of the features or components shown in the drawings or discussed below should be taken as mandatory for any specific implementation of any of these devices, systems, or methods unless specifically designated as mandatory.

Also, for any methods described, regardless of whether the method is described in conjunction with a flow diagram, it should be understood that unless otherwise specified or required by context, any explicit or implicit ordering of steps performed in the execution of a method does not imply that those steps must be performed in the order presented but instead may be performed in a different order or in parallel.

As used herein, the term “exemplary” is used in the sense of “example,” rather than “ideal.” Moreover, the terms “a” and “an” herein do not denote a limitation of quantity, but rather denote the presence of one or more of the referenced items.

The present disclosure provides systems and models for inferring irrigation events and monitoring water usage and ecosystem attributes of irrigated fields. Various models according to embodiments of the present disclosure employ machine learning methods to identify irrigation trends based upon temperature readings, and use them to predict irrigation needs and calculate water savings and methane emissions. In some embodiments, these models may be validated through a comparison with established irrigation models using a paired sensor approach, where the temperature sensor data was compared to a vibration dataset measured at the same location, demonstrates their ability to translate the recorded data into accurate monitoring systems of the irrigation events for the crop fields of interest. Results from this approach, discussed below, demonstrate that the deployment of temperature sensors can provide an accurate monitoring system for irrigation events throughout a field, including water volume and flood status through a growing season. Water volume and flood status can be used to calculate savings in water use and methane emissions. Flood status can be determined by whether the soil is visible (dry) or submerged (wet). Water volume can be estimated in any number of ways, including by multiplying a pump timing (time during which the pump is turned on) by a known flow rate of water through the pump or using a water balance model (for example, a field level water balance model). One of the water balance model input requirements is a time series of daily irrigation activity on the field. For example, irrigation event time series may be generated by the sensors and methods described herein.

The detection of irrigation events can be key inputs to determining various ecosystem attributes of agricultural production. As used herein “ecosystem attributes” refers to an environmental characteristic (for example, as a result of agricultural production) that may be quantified and valued (for example, as an ecosystem credit or sustainability claim). Examples of ecosystem attributes, goals, or benefits include without limitation an amount of water used (for instance, relative to a water limitation or schedule); an amount, type, and or timing of nitrogen use; a quantity and permanence of soil carbon sequestration; an amount of greenhouse gas (for example, methane) emission emitted or avoided, the like.

Methods of quantifying ecosystem attributes can include applying one or more biogeochemical models, empirical models, process-based models, machine learning models, ecosystem service models, models based on remotely sensed data, life-cycle assessment and inventory models, ensemble models, food web models, population models, direct measurement and statistical sample designs, crop growth models, or combinations thereof. In some embodiments, one or more irrigation events (for example, a time series of irrigation events) or related attributes (including without limitation, duration (e.g. days) and or frequency of periods of dry soil, volume of water, temperature of water, etc.) are inputs to one or more models for quantification of ecosystem attributes, for example, process based models such as DayCent, DNDC, and related models.

Compared to alternative approaches, models described herein provide a less expensive and more reliable method of inferring and monitoring irrigation events, using fewer and simpler sensors, facilitating better understanding of water usage, and providing an accurate in-season representation of irrigation events.

In various embodiments, an ambient temperature sensor is deployed on each field, eliminating a need for manual irrigation logs or usage of expensive or complicated sensors, while providing a more reliable dataset. Details of the deployment, including location and status are also recorded. The temperature sensor is used to detect when the water pump is turned on, as ground water is generally cooler than the air temperature during the growing season. When the water flows out of the water pump, the temperature sensor is submerged and records this lower temperature. Due to the high specific heat capacity of water, continuous cold water flow from the pump not only cools off the temperature sensors but also acts as a buffer against relatively drastic changes in air temperature. Generally, the difference between the lower water temperature and the higher air temperature, as well as the reduced temperature fluctuations, indicates when an irrigation event is occurring, and the model uses this information to further calculate the volume of water used during the irrigation events. Air temperature may be colder than water temperature in some climates, during some seasons, and or during some times of day. In some embodiments, temperature sensor data are trimmed to exclude data points from such regions, seasons, and or time periods.

In some embodiments, the ambient air temperature for a field or location is determined by combining multiple ambient air temperature measurements. For instance, ambient air temperature sensors can be located at fields adjacent to a target field, and the average ambient air temperature measurements from these sensors can be determined and correlated with the target field. Likewise, in the event that the ambient air temperature is known for various locations within a region, the ambient air temperature can be modeled for a target field based on a proximity of the target field to the locations within the region at which the ambient air temperature is known (e.g., as an average of these ambient air temperatures, weighted by proximity).

It should be noted that in practice, the ambient air temperature measurements and the field temperature measurements may include a time series of temperature measurements for various time points within a time interval. Accordingly, identifying irrigation events based on a comparison of ambient air temperature and field temperate can include identifying portions of ambient air temperature and field temperature data that correspond to a same, similar, or overlapping time interval. Likewise, identifying irrigation events based on a comparison of ambient air temperature and vibration data, accelerometer data, displacement data, etc., can include identifying portions of ambient air temperature data and vibration/accelerometer/displacement data that correspond to a same, similar, or overlapping time interval. In some embodiments, one or more of ambient air temperature, field temperature, vibration data, accelerometer data, displacement data, or any other data associated with the detection of irrigation events can be inferred for time intervals or at time points with less frequent data (e.g., based on similar data for adjacent fields, based on patterns or trends in data during these time intervals, and the like).

To accurately relay the readings from the temperature sensors, orthogonal sources of truth are paired up in a limited number of fields to generate a training dataset and design a model that indicates when the water is turned on for the fields. By using the temperature sensors combined with the trained model, the relatively inexpensive and mechanically simpler temperature sensors can be used for the measurement and verification of water events over a number of fields.

In order to track when a field is irrigated and how much water flows onto the field, it is important to know when a pump is on or off and the flow rate through the pump. The standard method of collecting this data is to install a flow meter with telemetry to the pump. The meter records (1) how much water flows; and (2) when it flows, and sends that data to a cloud network. However, this standard method can be prohibitively expensive for large-scale ventures. A disclosed embodiment uncouples the two steps. Instead of measuring both the amount of water flowing and when it flows at the meter, an inexpensive temperature sensor is used to determine when the pump is on. To determine the flow rate of the water source, a flow rate is measured just once at the beginning of the growing season. As the flow rate is not highly variable, this initial measurement can be paired with the pump on/off times as measured by the temperature sensors. This method may cost significantly less than the standard approach, in some embodiments 1%-10% of the cost per field.

To display and interpret the raw data from the temperature sensors, a model is developed using a classifier, logistic regression, or an artificial neural network to predict the status of the water pump at each observed point. The model looks at each point individually, in some embodiments without considering the specific series (i.e., period of observation by the temperature sensor on a given riser of a water pump) that it came from. To help train the model, additional features that encode information about the series each point belongs to and specific windows around the point can be built into the model. These features may be associated with a changepoint algorithm, and may be optimized for classification performance. Table 1, below, describes the additional features using a temperature sensor (in this example a HOBO sensor by Onset). In some examples, only a subset of the features described in Table 1 are used, for example, the subset of log_rsdl, rmeanl, and sdiff_uqt may be encoded into the classifier, or may be used to featurize and/or train a machine-learned model, such as the machine-learned models described herein.

TABLE 1
Example feature that may be encoded into the classifier.

| feature name | description |
|---|---|
| temp_f_trimmed | sensor temperature series where the observed |
| | temperature is capped at estimates of air temperature |
| | from NLDAS. This avoids erroneously high |
| | temperatures that are sometimes seen from the |
| | sensor devices when exposed to direct sunlight and |
| | irrigation is not running. |
| temp_diff_trimmed | The difference between NLDAS air temperature |
| | estimates and temp_f_trimmed |
| frmean | Mean sensor temperature of a forward looking |
| | window |
| rrmean | Mean sensor temperature of a backward looking |
| | window |
| rmeanl | The lower value of frmean and rrmean for a |
| | time point |
| mean_ratio | frmean/rrmean |
| frsd | Standard deviation of sensor temperature for a |
| | forward-looking window. |
| rrsd | Standard deviation of sensor temperature variance |
| | for a backward-looking window. |
| rsdl | The lower value of frsd and rrsd for a time point |
| log_rsdl | The logarithm transformation of rsdl |
| temp_uqt | Regional counterfactual from the 80^{th} percentile |
| | of a group of geographically close temperature |
| | sensors |
| diff_uqt | The difference between temperature measurement |
| | from a temperature sensor and temp_uqt |
| sdiff_uqt | The scaled difference between temperature |
| | measurement from a temperature sensor and |
| | temp_uqt, i.e., diff_uqt/temp_uqt |

A number of classifiers can be used with the temperature tracking model. The tracking model is also used to describe what has happened at the field specific temperature sensor, and predicts what would have happened if the water source were not turned on.

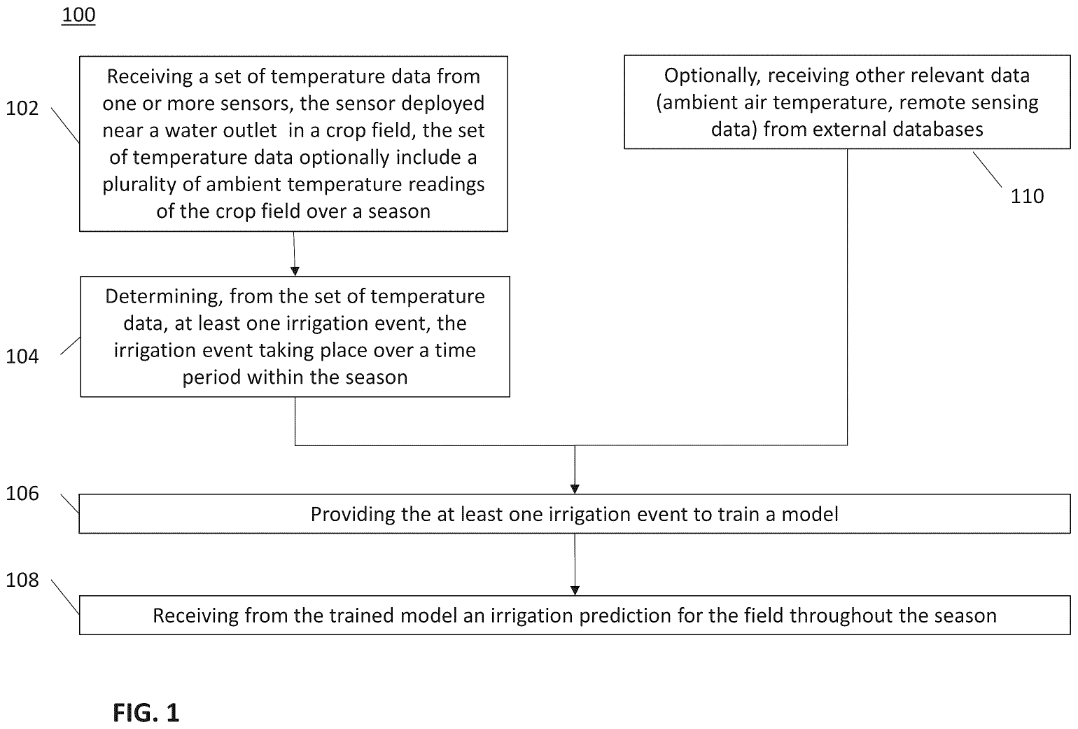

FIG. 1 is a flowchart of an exemplary method 100 for monitoring irrigation events, according to an exemplary embodiment of the present disclosure. For example, exemplary method 100 (e.g., steps 102-108) may be performed by a processor automatically or in response to a request from a user.

According to embodiments disclosed herein, the exemplary method 100 for monitoring irrigation events may include one or more of the following steps. In step 102, the method may include receiving a set of temperature data from a sensor in a crop field, the sensor deployed adjacent to a water outlet, for example an outlet for irrigation water flowing into a field such as downstream of a pipe, polypipe, at a riser, outlet of a water pump, etc. Optionally, the set of temperature data include a plurality of ambient temperature readings of the crop field over a season. The sensor can be a temperature sensor able to communicate with a system. Optionally the sensor is deployed near a water outlet, where the sensor is close enough to an output pipe of the water pump to detect a change in water temperature when the water pump is activated in the case of a temperature sensor, or close enough to an output pipe of the water pump to detect a change in flow when the water pump is activated in the case of a vibration sensor. Generally, ground water flowing through the water pumps in a crop field is considerably colder than the ambient air temperature. Readings from the sensor reflect this by recording a lower temperature when the irrigation is active. Additionally, the temperature sensors can be used to infer a change of water level on the field, as the recorded by the water temperature sensor will converge toward the ambient air temperature when the water level falls below the level where the water temperature is placed. Periods of dry soil can result in more reductions in emissions, as methane is created in submerged soil. If the soil is submerged for a shorter period, less methane is produced. Accordingly, the temperature sensors can provide data to not only infer water usage, but also help in decreasing emissions from the crop fields.

According to embodiments disclosed herein, the sensor is a temperature sensor such as a HOBO sensor. Such temperature sensors are tiny (thumb sized) and inexpensive ($30-45) sensors that record a local temperature. When immersed in ground water, such sensors register noticeable temperature drops. In addition to their small size and cost-effectiveness, the sensor is an efficient datalogger that sends temperatures recorded at 15 to 30 minute intervals to a central processor or device for analysis. These recordings provide a robust set of data from which irrigation events can be identified and further predicted.

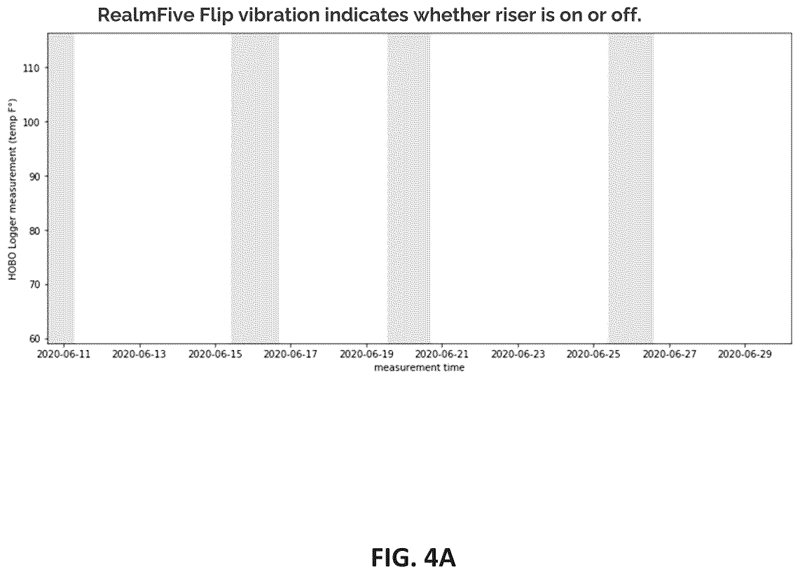

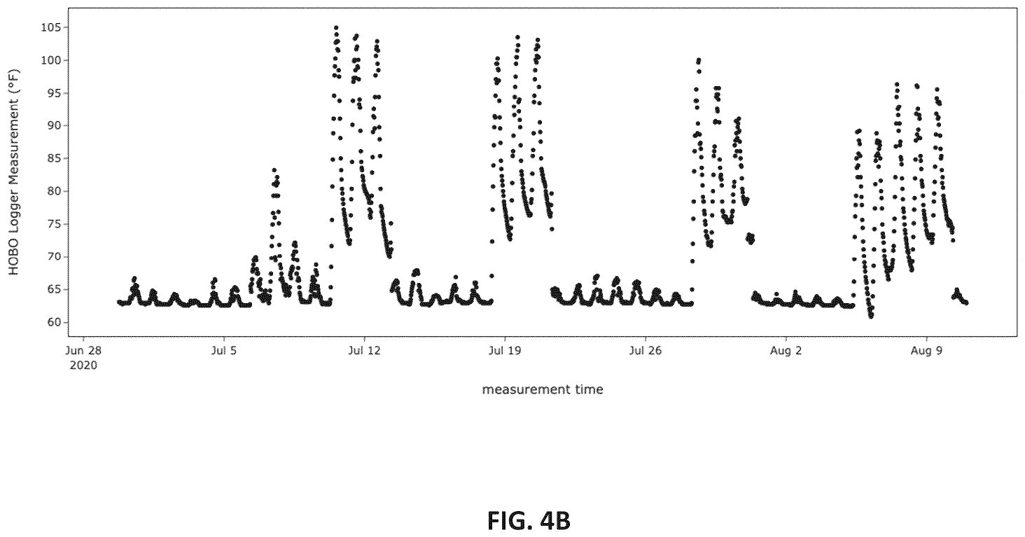

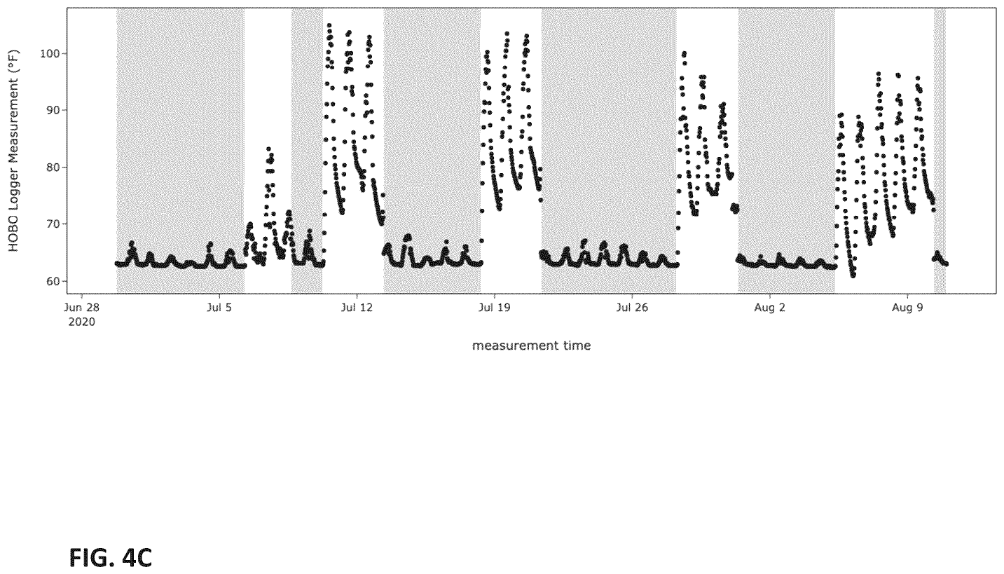

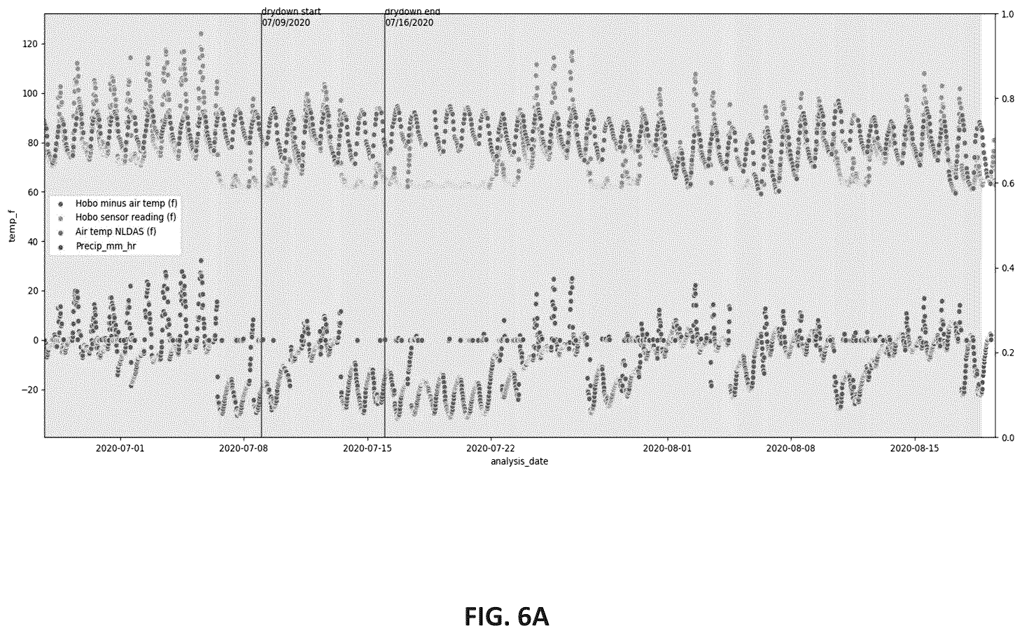

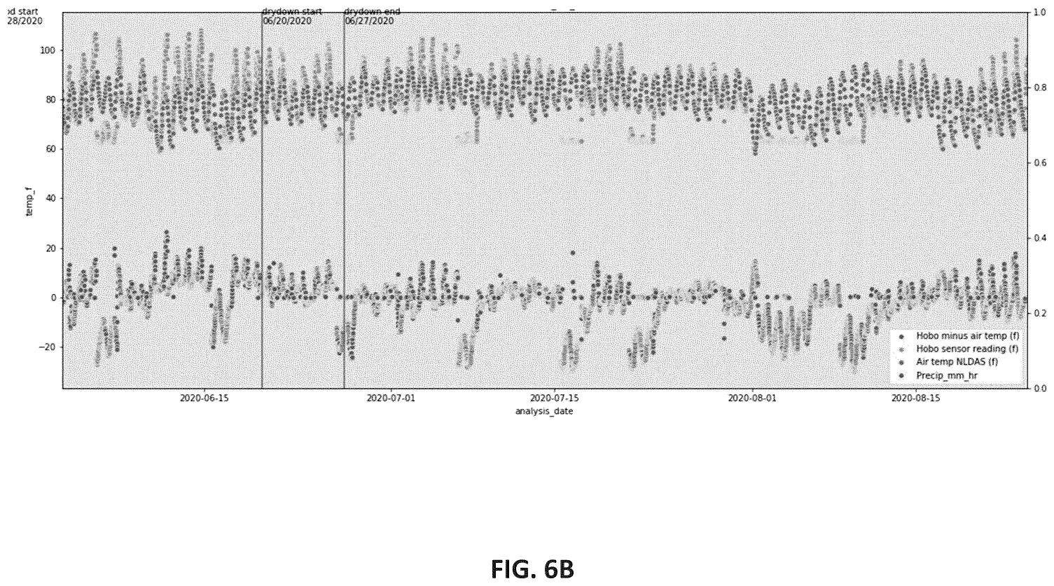

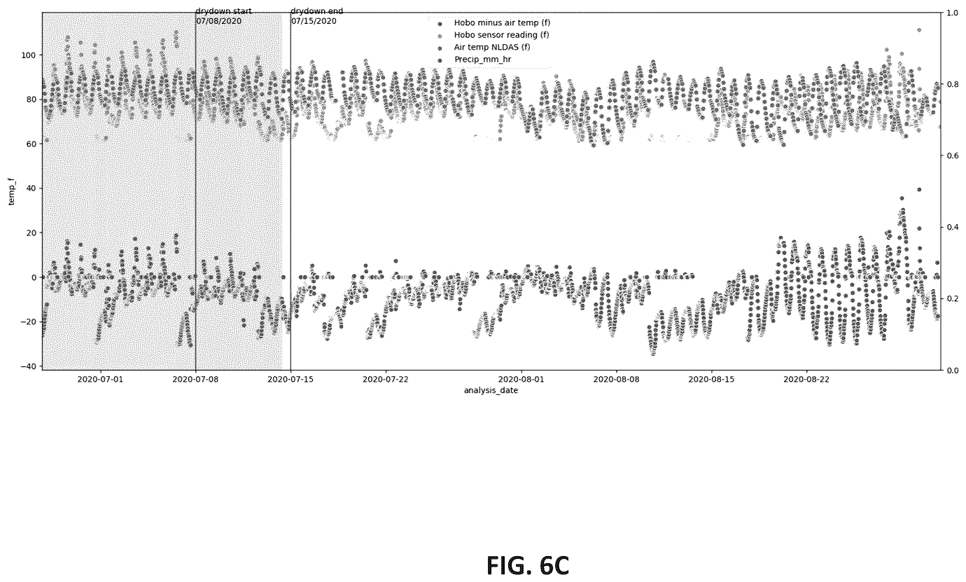

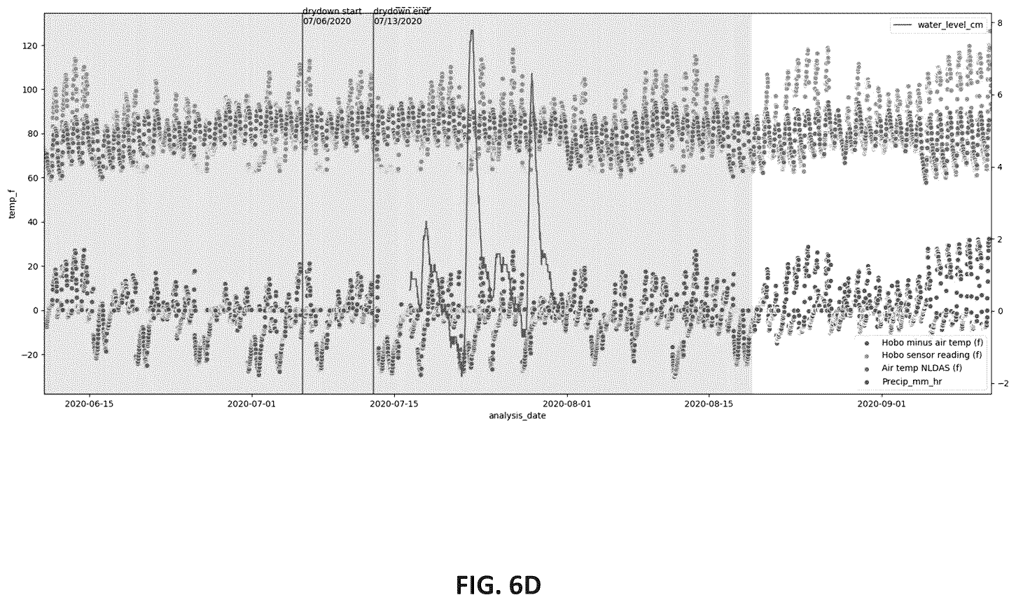

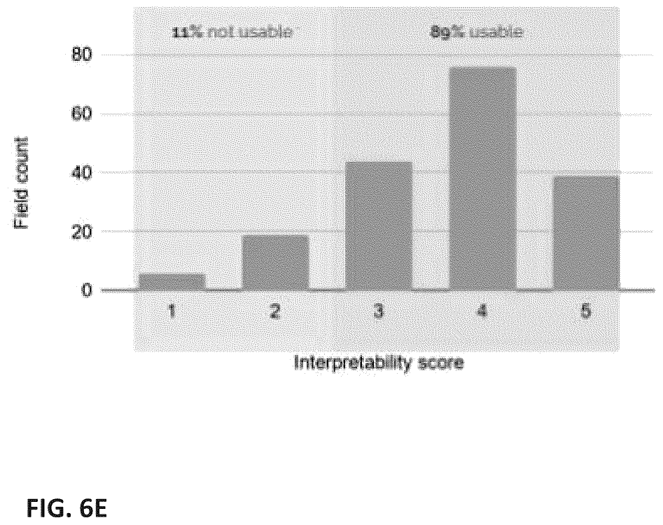

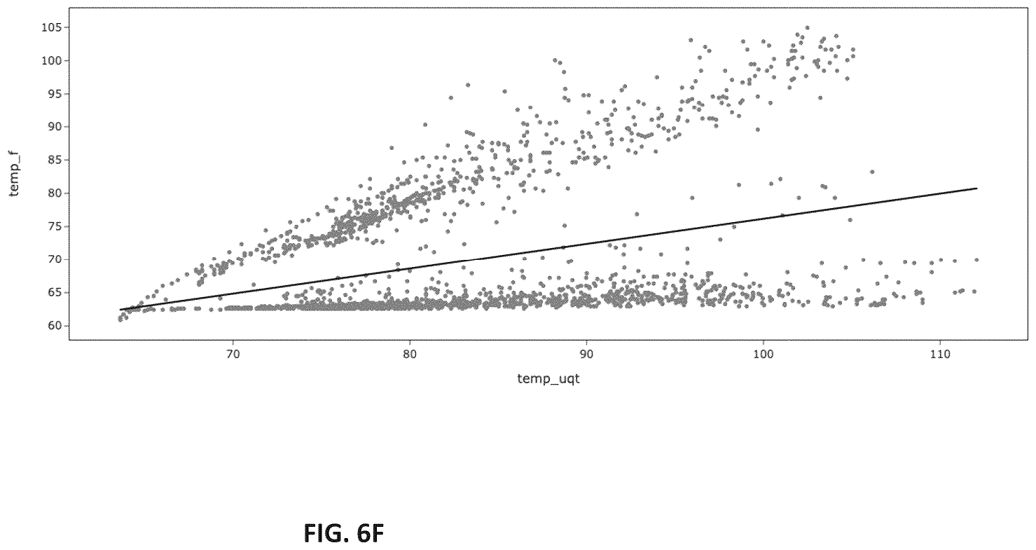

The use of temperature sensors can be verified by mapping the recorded temperature data to vibration data recorded over the same time period. In some embodiments, the vibration sensors (for example, accelerometer, displacement sensor, etc.) are placed directly on a surface of the water pump and record a period where the pump is on, as determined by the vibration of the pump. In some embodiments, the vibration sensor is attached to a substrate (for example, a stake, or tether) to which a temperature sensor is also attached, and the substrate is placed in a location that is affected by turbulent flow of water during irrigation (for example, in, on, or close to a water outlet). Optionally, the substrate to which a vibration sensor is attached may contain at least one stiff region and one flexible region (for example, a spring). A portion of the substrate may be inserted in the soil or is attached to irrigation equipment (e.g. a pipe, water pump outlet, polypipe, etc.). Optionally, a flexible region of a substrate is located between a portion of the substrate that is anchored (e.g. inserted in the soil or attached to irrigation equipment) and a vibration sensor. In some embodiments, a substrate is a stake secured vertically in the soil, wherein the substrate has a lower rigid region and flexible region (e.g. a spring, a thin region, an elastomer) connecting the top end of the lower rigid region to the bottom end of a upper rigid region (e.g having a vibration sensor at the top region of the rigid upper region). In some embodiments, a substrate is a stake secured vertically in the soil, wherein the substrate has a lower rigid region and flexible region (e.g. a spring, a thin region, an elastomer) connecting the top end of the lower rigid region to a vibration sensor. As shown by the data in FIGS. 4A-4C, the temperatures measured by the sensors correlate to the time periods when the pump was on, as determined by the vibration sensors. This correlation can be tracked throughout all fields monitored by both vibration and temperature sensors, as shown in FIG. 6A. It should be noted that the machine-learned models described herein can additionally be trained on vibration data, accelerometer data, displacement sensor data, or any other data indicative of or correlated to historical irrigation events.

In some embodiments, the sensor is placed on a vertical stake near the water pump. The sensor is placed at a height on the stake, where the height allows for the sensor to be completely submerged when a water pump is actively flowing. The submerged sensor records the water temperature. The sensor is placed in a location that is consistently submerged during water flow from the irrigation, but is not affected by excessive water movement and turbidity. In some embodiments, a vibration sensor is placed in a location that is affected by water movement and turbidity during irrigation (for example, in, on, or close to a water outlet), optionally the vibration sensor is attached to substrate (for example, a stake) to which a temperature sensor is also attached. The stake is placed as closely as possible to the water outlet, to ensure the water temperature change due to an active pump is accurately recorded. Some agricultural fields are furrowed in order to better water crops. In these cases, the stake can be placed either in the furrow, to ensure that the sensor is submerged, or out of the furrow, where the placement of the sensor on the stake can ensure that the sensor will be completely submerged by the water. In fields with varying elevation, water near the top of the field is generally cooler; as such, the placement of both the sensor and the stake may require additional adjustment to ensure that the sensor can be fully submerged.

In step 104, the method may include determining, from the set of temperature data, at least one irrigation event at the water pump, the irrigation event taking place over a time period within the season. The irrigation event is a period of time where the recorded temperature remains below a temperature threshold, the sustained period of time being longer than a threshold time. An irrigation event reflects a time period when the water pump is on, and the temperature sensor is submerged in water. This submersion causes the lower temperature readings, as the ground water temperature is colder than the ambient air temperature. As the water level can vary based on environmental conditions, temperature sensors for measurement of water temperature can be placed in a location 2-3″ from the ground. When the water pump has a single outlet, the sensor is placed near the outlet. When the water pump has multiple outlets in a single pipe, the sensor can be placed near a first outlet having the coldest water.

Where there is no irrigation, there is a sharp oscillation across the recorded temperatures on a daily basis. When a ground water irrigation event occurs, there is a drop in temperature as the sensor is submerged. While the sensor is submerged, oscillations are dampened due to the high specific heat capacity of water. These dampened oscillations indicate the occurrence of an irrigation event.

In disclosed embodiments, two sensors are used to collect temperature data. The first and second sensors are placed on a same vertical axis such as a wooden stake next to the water pump, where the first sensor is in a position such that the sensor is submerged in the water when the water pump is active. The second position is spaced above the first sensor so that the sensor will not be submerged when the water pump is active. This second sensor records the ambient air temperature at the water pump, without recording the water temperature. The recorded temperatures from the two sensors can then be compared, using the second sensor's readings as a counterfactual, illustrating what the first temperature sensor would record if the water pipe was not turned on and the irrigation event did not occur. For example, a sudden decrease in temperature recorded by the first sensor can be compared with the temperature over the same time period recorded by the second sensor to determine whether an irrigation event has occurred.

In step 106, the method may include providing the at least one irrigation event to train a model. Alternately, the method may comprise an unsupervised machine-learned model. The model can be a neural network, including a convolutional neural network. The trained model can be configured to assign a label (such as irrigation event). Here, the input is the temperature data and the at least one irrigation event, which the model uses to determine a localized irrigation model. Optionally, the method may include receiving input comprising one or more data from external databases, for example, ambient air temperature, remote sensing data, etc. 110.

In step 108, the method may include receiving from the trained model an irrigation prediction for the field throughout the season. The irrigation prediction illustrates a pattern of irrigation over the growing season based on the input temperature data, and can also calculate a total volume of water used over the course of the growing season. This volume is found by aggregating a total time for which the water pump was active, and multiplying that time by a determined flow rate of water through the water pump or using a water balance model (for example, a field level water balance model).

In some embodiments, in response to detecting one or more irrigation events, one or more additional irrigation events can be initiated. For instance, if it is determined that the detected irrigation events are not sufficient to provide irrigation to a field, additional irrigation events can be initiated to ensure that sufficient irrigation is provided. In some embodiments, in response to detecting one or more irrigation events, one or more pre-planned or pre-schedule irrigation events can be canceled, for instance in response to determining that a field is being over-irrigated.

In some embodiments, in response to detecting one or more irrigation events, one or more additional irrigation events can be modified. For instance, a current irrigation event detected in real-time can be modified, or one or more characteristics of future irrigation events can be modified. Examples of irrigation event modifications include but are not limited to increasing a length of a planned or current irrigation event, reducing the length of the irrigation event, increasing a flow of the irrigation event, decreasing the flow of the irrigation event, modifying a start time of the irrigation event, modifying an end time of the irrigation event, and canceling the irrigation event.

In some embodiments, one or more irrigation events can be added, modified, or canceled in response to determining that a current schedule of irrigation events is likely to cause an undesired change to an ecosystem attribute, profile, or goal. For instance, an ecosystem model can be applied to an identified or scheduled set of irrigation events in order to measure or quantify some ecosystem attribute or characteristic. A schedule of irrigation events can be modified in response to determining (for instance), that the measured or quantified ecosystem attribute exceeds a threshold, falls below a threshold, or causes a change in an ecosystem attribute profile. For example, in response to determining that a planned irrigation event schedule would cause an above-threshold emission of methane or another greenhouse gas, one or more of the irrigation events can be canceled or shortened in length. In such embodiments, the ecosystem model can be an emissions prediction model configured to predict methane or other emissions based on an aggregated total of dry soil (since dry soil emits less methane than wet or moist soil). Accordingly, irrigation events can be modified as needed to maintain a target greenhouse gas emissions profile.

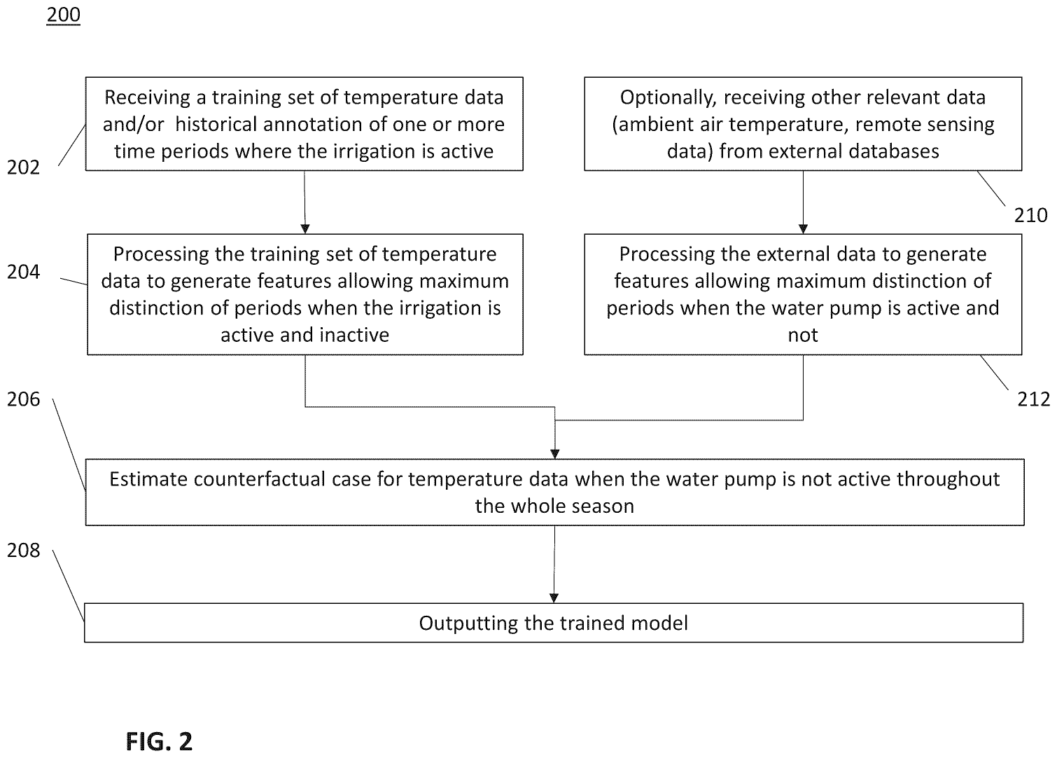

FIG. 2 is a flowchart of an exemplary method 200 for training an irrigation model, according to an exemplary embodiment of the present disclosure. For example, exemplary method 200 (e.g., steps 202-210) may be performed by a processor automatically or in response to a request from a user.

In some embodiments, a counterfactual scenario is generated. In one example, a counterfactual scenario is generated from the 80^{th} percentile of all temperature sensors for a geographic area, where the geographic area contains at least one field, at a specific time point. The 80th percentile is a proxy for ambient air temperature for non-submerged sensors. The model can learn a mapping from this regional counterfactual to a local reading, the mapping then being used to localize the counterfactual. It will be appreciated that alternative percentiles may be employed in order to achieve a balance between precision and generalizability. In another example, a counterfactual scenario is generated from a water balance model run without an input irrigation event time series and compared to a water balance model run with an input irrigation event time series generated from sensor data.

In step 204, the method may include processing the training set of temperature data to identify one or more time periods where the water pump is active. This training set is not the counterfactual for a specific temperature sensor deployed at a water pump, but rather is used to estimate the counterfactual for the specific temperature sensor, to which the training set is highly correlated. The estimation may use regression, for example linear regression, RANSAC regression, polynomial regression, quantile regression, elastic net regression, random forest regression, gradient boosting regression. An exemplary linear regression is shown in FIG. 6C. In this example linear regression is applied to all of the temperature data, where a specific sensor data is the target, and the training dataset is the regressor. When data points for the specific sensor and the training dataset are plotted as a scatter plot, two clusters of points are visible. One cluster represents irrigation occurring, the other cluster represents irrigation not occurring. To delineate the two clusters, a number of methods can be used. For example, a linear regression can be fit to the whole data. This underestimates the counterfactual, due to the inclusion of the irrigation times in the training data set. However, a conservative estimation is provided, which indicates that the true counterfactual is somewhere above this. Optionally, the method may include receiving input comprising one or more data from external databases, for example, ambient air temperature, remote sensing data, etc. 210, and processing the external data to generate features allowing maximum distinction of periods when the water pump is active and not 212.

This regression can be repeated where air temperature data is used as the regressor. It is contemplated that air temperature and the training data set as described above can be used together, but as the two are highly correlated it is generally considered unnecessary.

In step 206, the method may include comparing the identified one or more time periods where the water pump is active with a training record indicating when the water pump is active to identify at least one irrigation event. If the training value is lower than the conservative counterfactual value as estimated, then irrigation is actively occurring. Likewise, if the oscillation of the training data is lower than the conservative counterfactual, irrigation is actively occurring.

In step 208, the method may include outputting the trained model. The trained model can include a number of parameters defining an irrigation event, and can assign a probability of an irrigation event at each time point in an input data set. The probability ranges can be determined by an iterative process.

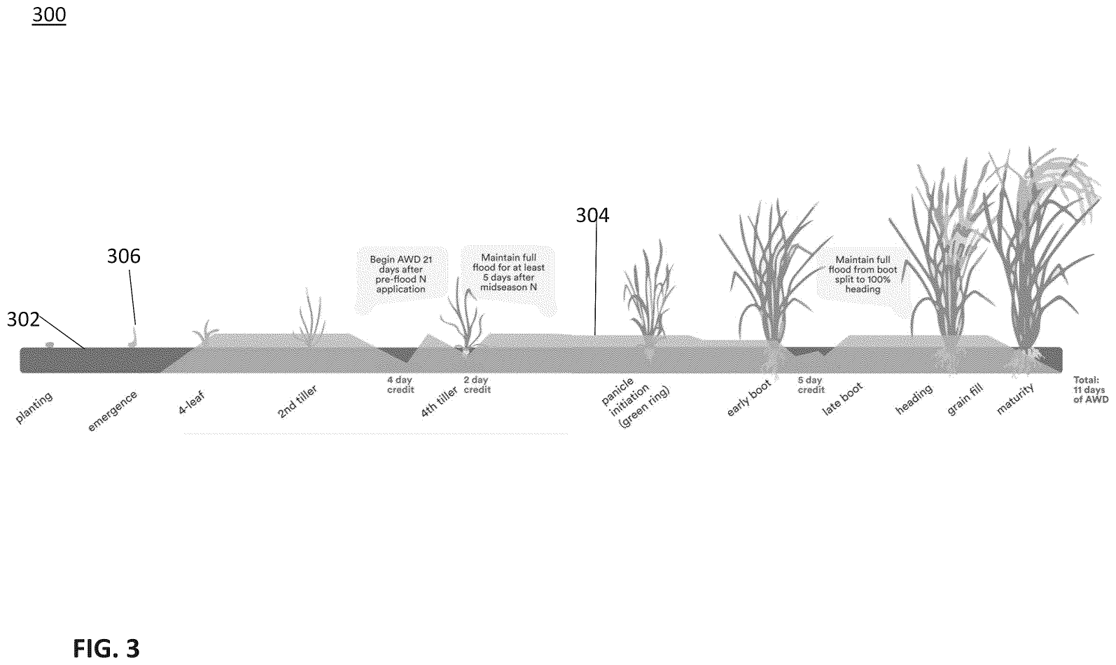

FIG. 3 is a graphic showing the water level cycle within a field during a growing season. As shown in illustration 300, irrigation events can begin after a plant 306 has emerged from the soil 302. The water level 304 varies, but generally adheres to an alternate wetting and drying schedule, which can begin 21 days after a pre-flood application. The water level 304 is generally maintained throughout the growing season. Prior to the midseason, the soil 302 may be allowed to dry for a period to decrease methane emissions. Plants are maintained at a full flood level for at least 5 days after a midseason point. An additional drying event can occur after the early book point, but after full flooding status is maintained from a boot split to 100% heading of the plants. This exemplary pattern of providing and maintaining a water level 304 can be used in a variety of crop fields, but is most commonly used in rice fields.

FIG. 4A is a graph indicating whether a pump is turned on or off, based on a vibration sensor located at riser pipe in a field, over an 18 day time period. Shaded areas indicate that the vibration is occurring on a surface of the riser, generally indicating whether a pump within the riser is on or off. The vibration continues for the entirety of the irrigation event, providing a block of time over which the irrigation event occurs.

FIG. 4B is a graph showing temperature readings over the same 18 day time period as shown in FIG. 4A. Daily temperature variation is shown, with a general pattern of temperatures rising and falling over a single day. However, there are notable occurrences of sustained lower temperature readings, where the temperature does not widely vary and remains between 60 and 70 degrees. These sustained lower temperatures are indicative of an irrigation event, where the lower temperature reading is a result of the temperature sensor being submerged in cooler water from the water pump.

FIG. 4C is a graph overlaying the temperature data onto the vibration data. Here, the periods with sustained lower temperatures occur over the same time periods where the pump is vibrating while active, as per the vibration sensor data. As such, there is a correlation between temperature and vibration, indicating that temperature data can indicate when the water pump is active and the irrigation event is occurring.

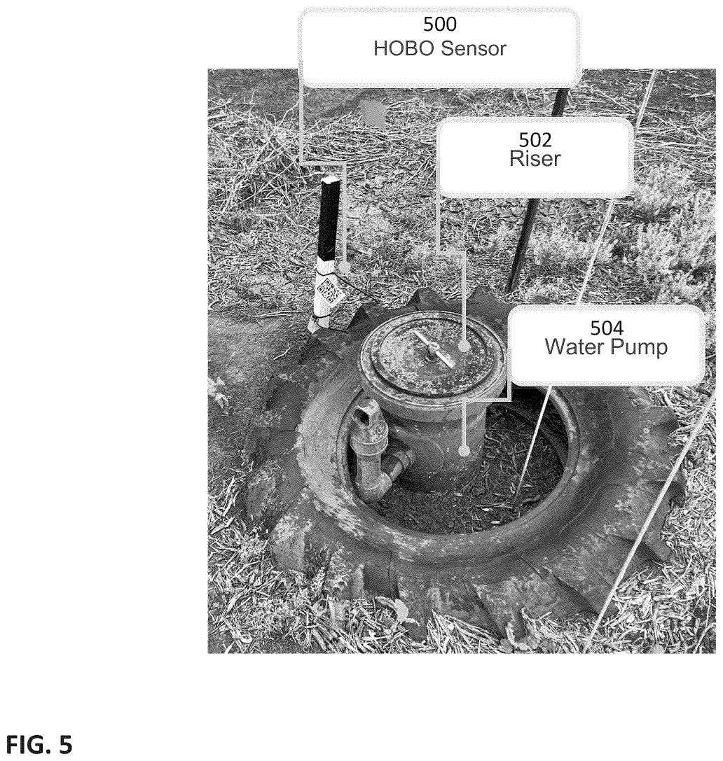

FIG. 5 is an exemplary placement of a temperature sensor, i.e., sensor 500 in relation to a riser 502 containing a water pump 504. In this exemplary embodiment, the sensor 500 is attached to a stake in close proximity to the riser 502, to ensure the change of temperatures resulting from water flow are accurately recorded. Sensor 500 is placed on the stake at a location that ensures the sensor is submerged when the pump is active

FIG. 6A is a graph further illustrating the correlation between the vibration sensor data and the data from two temperature sensors, based on readings from different crop fields over various time periods. There is a strong agreement between the indication of the irrigation events as determined by vibration, as measured by a RealmFive Flip sensor, and the indication of the irrigation events as determined by the temperature sensor. Irrigation events as determined by the vibration sensor are shown in shaded backgrounds, while the tracked temperatures include a sensor, a sensor measuring an ambient temperature minus a measured air temperature, as provided by the NLDAS, an air temperature provided by the NLDAS, and an indication of precipitation.

FIGS. 6B-E is a graph indicating the interpretability score of sensors across a variety of fields. Overall, the sensors have output interpretable results, as shown in the graphs of FIG. 6A.

FIG. 6F is an exemplary linear regression used to find a counterfactual temperature for the training data set. Two clusters of data points are visible, one on either side of the conservative estimate of the counterfactual. One cluster represents irrigation occurring, the other cluster represents irrigation not occurring. The ordinary linear regression can be fit to the whole data, as explained above.

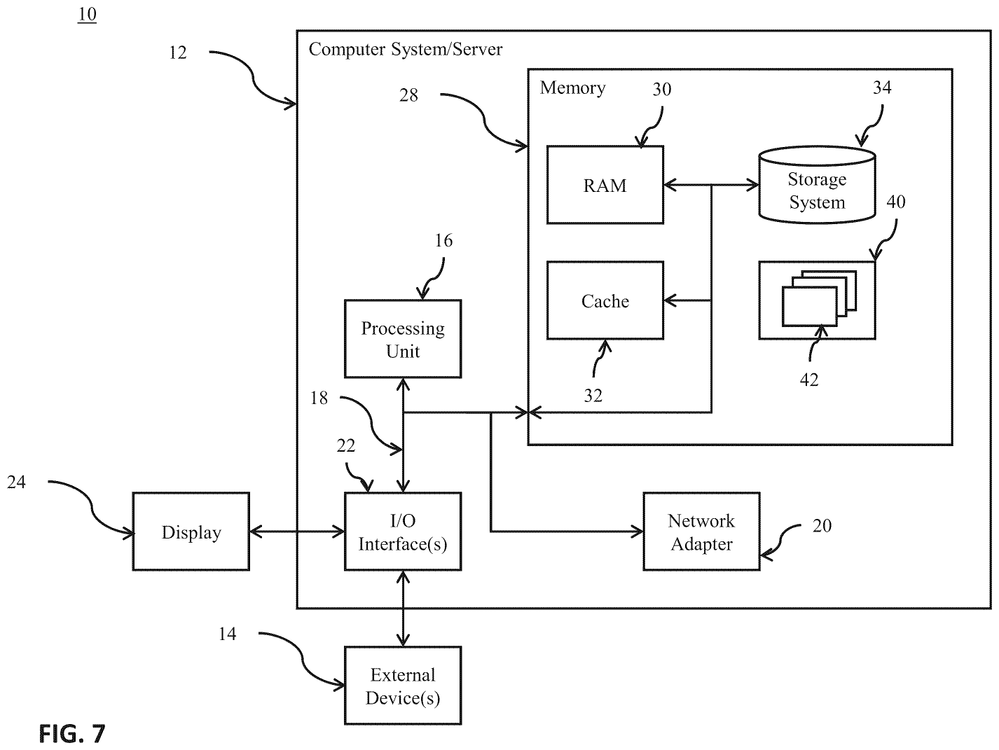

FIG. 7 is a schematic of an exemplary computing node. Computing node 10 is only one example of a suitable computing node and is not intended to suggest any limitation as to the scope of use or functionality of embodiments described herein. Regardless, computing node 10 is capable of being implemented and/or performing any of the functionality set forth hereinabove.

In computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed computing environments that include any of the above systems or devices, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed computing environments where tasks are performed by remote processing devices that are linked through a communications network. In a distributed computing environment, program modules may be located in both local and remote computer system storage media including memory storage devices.

As shown in FIG. 7, computer system/server 12 in computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, Peripheral Component Interconnect (PCI) bus, Peripheral Component Interconnect Express (PCIe), and Advanced Microcontroller Bus Architecture (AMBA).

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Algorithm Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the disclosure.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

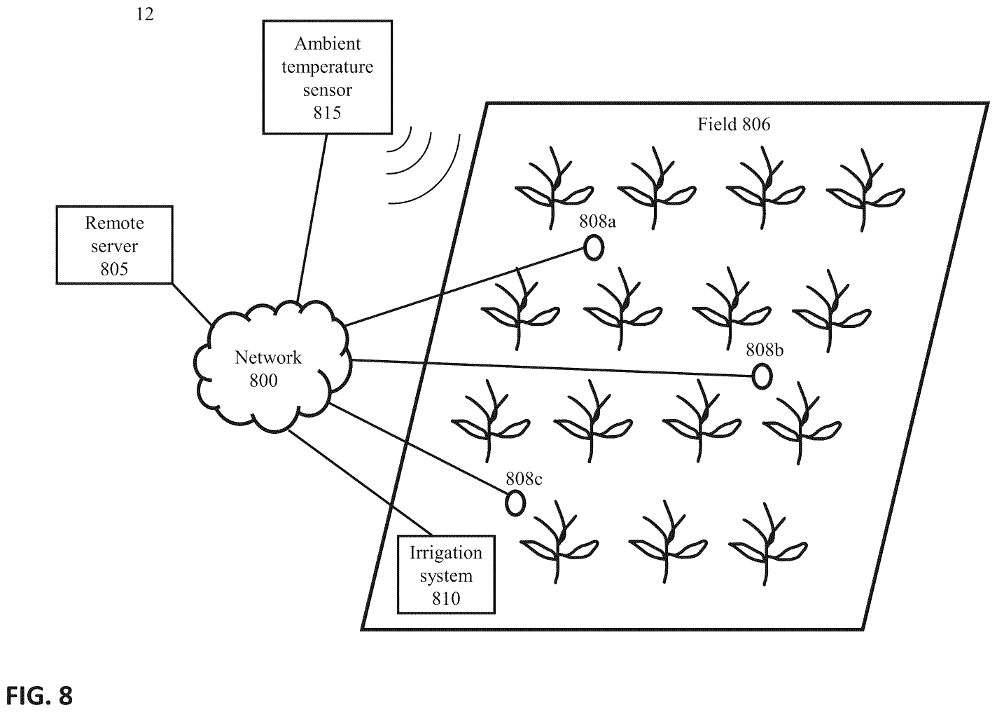

FIG. 8 illustrates an example system environment, according to the principles described herein. The environment of the embodiment of FIG. 8 includes a remote server 805, a set of remote temperature sensors 808 (including sensor 808a, 808b, and 808c) deployed in a field 806, an irrigation system 810, and an ambient temperature sensor 815. It should be noted that in other embodiments, the environment illustrated in FIG. 8 can include fewer, different, or additional components or systems than those described herein.

The remote server 805 can be any computing system (such as the computer system/server 12) capable of receiving temperature measurements or signals from the remote temperature sensors 808 and the ambient temperature sensor 815, and capable of detecting irrigation events based on one or more of these temperature measurements or signals. In some embodiments, the remote server 805 includes a learning system configured to train and/or apply a machine-learned model configured to identify or predict irrigation events as described herein. In some embodiments, the machine-learned model can be trained on historic temperature measurement data, on temperature measurement data received from the sensors 808 and 815, on remote temperature data received from an external data source, on irrigation data received from the irrigation system 810, and/or on irrigation or temperature information received from any other source. It should be noted that the remote server 805 may be located at any location, for instance within the field 806, adjacent to the field, or at any distance remote from the field.

The remote temperature sensors 808 are described above. In some embodiments, the remote temperature sensors 808 are installed, affixed, mobile, or otherwise located at the field 806. The remote temperature sensors 808 are configured to measure a temperature at the field 806, and are configured to communicate the measured temperatures to the remote server 805 via the network 800. In some embodiments, the remote temperature sensors 808 communicate wirelessly or via wire connection with the network 800 via one or more relays, access points, routers, transceivers, or other equipment not illustrated in FIG. 8. In some embodiments, one or more of the remote temperature sensors are located above a minimum waterline and below a maximum waterline within the field 806.

The irrigation system 810 is configured to irrigate or otherwise provide water to the field 806. In some embodiments, the irrigation system 810 includes one or more water pumps as described herein, and can include one or more pipes, sprinklers, or other water distribution equipment not illustrated in the embodiment of FIG. 8. The irrigation system 810 can communicate information about water provided to the field 806 to the remote server 805 via the network 800. In some embodiments, the irrigation system 810 is retrofitted to include one or more sensors configured to detect irrigation events and provide information about the irrigation events to the remote server 805.

The ambient temperature sensor 815 is configured to measure an air temperature at the field 806. In some embodiments, the ambient temperature sensor 815 is located at the field 806, for instance at a height greater than the maximum waterline within the field 806. In some embodiments, the ambient temperature sensor 815 is located remote from the field. For instance, the ambient temperature sensor 815 can be a set of temperature sensors located within a vicinity of the field 806, configured to average or otherwise combine measured temperatures as a proxy for the ambient air temperature of the field. In some embodiments, the ambient temperature sensor 815 is a satellite, weather balloon, or other system configured to compute an ambient air temperature of the field 806. The ambient temperature sensor 815 is configured to provide information about measured ambient air temperatures for the field 806 to the remote server 805 via the network 800.

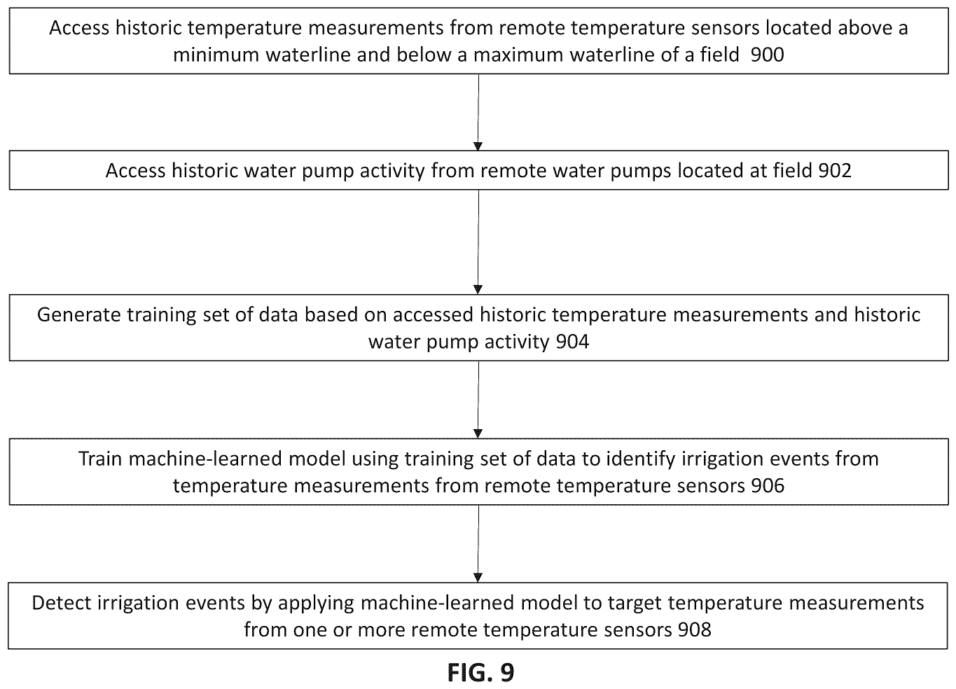

FIG. 9 is a flowchart illustrated an exemplary method of training an irrigation model, according to the techniques described herein. In some embodiments, the method of FIG. 9 includes fewer, additional, or different steps than those illustrated in FIG. 9.

Historic temperature measurements are accessed 900 from remote temperature sensors located above a minimum waterline and below a maximum waterline of a field. In some embodiments, these historic temperature measurements are not directly accessed from the remote temperature sensors, but are instead accessed from a database or other data source that previously received the historic temperature measurements.

Historic water pump activity is also accessed 902 from water pumps in a field. The historic water pump activity can include times, durations, and flows of irrigation events. The historic water pump activity can be received from water pumps, from sensors on or adjacent to the water pumps, from remote sensors configured to detect irrigation events (e.g., by measuring light reflection on the field), or from a remote data source that has previously received information about the historic water pump activity.

A training data set is generated 904 based on the accessed historic temperature measurements and the historic water pumped activity. The training data set is then used to train 906 a machine-learned model to identify irrigation events at a field based on temperature measurements from remote temperature sensors located at the field. Irrigation events are then detected 908 by applying the machine-learned model to temperature measurements received from the remote temperature sensors.

Various models are described or referred to herein. In some embodiments, each, or one or more of these models may be machine-learned models, which may be trained, stored, accessed, and/or applied by a learning system. In some embodiments, the learning system is implemented within a remote server or system located at or remote from a field. In some embodiments, a feature vector is provided to a learning system. Based on the input features, the learning system generates one or more outputs. In some embodiments, the output of the learning system is a feature vector. In some embodiments, the learning system comprises an SVM. In other embodiments, the learning system comprises an artificial neural network. In some embodiments, the learning system is pre-trained using training data. In some embodiments training data is retrospective data. In some embodiments, the retrospective data is stored in a data store. In some embodiments, the learning system may be additionally trained through manual curation of previously generated outputs.

In some embodiments, the learning system is a trained classifier. In some embodiments, the trained classifier is a random forest. However, it will be appreciated that a variety of other classifiers are suitable for use according to the present disclosure, including linear classifiers, support vector machines (SVM), or neural networks such as recurrent neural networks (RNN).

Suitable artificial neural networks include but are not limited to a feedforward neural network, a radial basis function network, a self-organizing map, learning vector quantization, a recurrent neural network, a Hopfield network, a Boltzmann machine, an echo state network, long short term memory, a bi-directional recurrent neural network, a hierarchical recurrent neural network, a stochastic neural network, a modular neural network, an associative neural network, a deep neural network, a deep belief network, a convolutional neural networks, a convolutional deep belief network, a large memory storage and retrieval neural network, a deep Boltzmann machine, a deep stacking network, a tensor deep stacking network, a spike and slab restricted Boltzmann machine, a compound hierarchical-deep model, a deep coding network, a multilayer kernel machine, or a deep Q-network.

The training of the machine-learned models described herein (such as neural networks and other models referenced herein) include the performance of one or more non-mathematical operations or implementation of non-mathematical functions at least in part by a machine or computing system, examples of which include but are not limited to data loading operations, data storage operations, data toggling or modification operations, non-transitory computer-readable storage medium modification operations, metadata removal or data cleansing operations, data compression operations, image modification operations, noise application operations, noise removal operations, and the like. Accordingly, the training of the machine-learned models described herein may be based on or may involve mathematical concepts, but is not simply limited to the performance of a mathematical calculation, a mathematical operation, or an act of calculating a variable or number using mathematical methods.

Likewise, it should be noted that the training of the models describes herein cannot be practically performed in the human mind alone. The models are innately complex including vast amounts of weights and parameters associated through one or more complex functions. Training and/or deployment of such models involve so great a number of operations that it is not feasibly performable by the human mind alone, nor with the assistance of pen and paper. In such embodiments, the operations may number in the hundreds, thousands, tens of thousands, hundreds of thousands, millions, billions, or trillions. Moreover, the training data may include hundreds, thousands, tens of thousands, hundreds of thousands, or millions of temperature measurements. Accordingly, such models are necessarily rooted in computer-technology for their implementation and use.

The present disclosure may be embodied as a system, a method, and/or a computer program product. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A remote irrigation system, comprising:
a first set of one or more temperature sensors deployed in a field, at least one temperature sensor affixed at a height above a minimum waterline of the field and below a maximum waterline of the field, the first set of temperature sensors configured to measure a field temperature associated with the field;
a second set of one or more temperature sensors configured to measure an ambient air temperature associated with the field; and
a remote server comprising:
a transceiver configured to receive field temperature data from the first set of temperature sensors and ambient air temperature data from the second set of temperature sensors; and
a controller configured to identify irrigation events within the field over a time interval by identifying time periods within the time interval during which the field temperature data is dampened relative to the ambient air temperature data.

2. The remote irrigation system of claim 1, further comprising:
a water pump configured to implement an irrigation event for the field.

3. The remote irrigation system of claim 2, wherein the controller is configured to, via the transceiver, modify an operating mode of the water pump by initiating one or more additional irrigation events for the field based on the identified irrigation events.

4. The remote irrigation system of claim 2, wherein the controller is configured to, via the transceiver, modify an operating mode of the water pump by bypassing one or more preplanned irrigation events for the field based on the identified irrigation events.

5. The remote irrigation system of claim 1, wherein a height of the minimum waterline is selected such that the at least one temperature sensor is not submerged when an irrigation event is not occurring.

6. The remote irrigation system of claim 1, wherein a height of the maximum waterline is selected such that the at least one temperature sensor is submerged when an irrigation event is occurring.

7. The remote irrigation system of claim 1, wherein the controller is configured to identify irrigation events within the field by applying a machine-learned model to the field temperature data and the ambient air temperature data, the machine-learned model trained on historical field temperature data and associated historical ambient air temperature data, wherein a first set of portions of the historical field temperature data are flagged as corresponding to irrigation events and wherein a second set of portions of the historical field temperature data are flagged as not corresponding to irrigation events.

8. A method for managing an irrigation system of a field, comprising:
accessing, by a central server, historic temperature measurements from one or more remote temperature sensors located above a minimum waterline and below a maximum waterline within the field;
accessing, by the central server, historic water pump activity from one or more remote water pumps located at the field;
generating, by the central server, a training set of data based on the accessed historic temperature measurements and the accessed historic water pump activity;
training, by the central server, a machine-learned model using the training set of data, the machine-learned model configured to identify one or more irrigation events from temperature measurements generated by the one or more remote temperature sensors; and
detecting a set of irrigation events by applying the machine-learned model to target temperature measurements from the one or more remote temperature sensors.

9. The method of claim 8, wherein the machine-learned model is further configured to predict characteristics for a set of future irrigation events, and to predict a total volume of water to be used during the set of future irrigation events.

10. The method of claim 9, wherein the predicted total volume of water is determined based on an aggregation of a total time for which the one or more remote water pumps are predicted to be active and based on a determined flow rate of water through the one or more remote water pumps when the water pumps are active.

11. The method of claim 8, wherein the machine-learned model is further configured to predict emissions for the field based at least in part on the identified irrigation events.

12. The method of claim 8, wherein the machine-learned model comprises a neural network, and wherein training the machine-learned model comprises iteratively training the neural network until the neural network can predict irrigation events corresponding to historic water pump activity from the historic temperature measurements with an above-threshold accuracy.

13. The method of claim 8, wherein the machine-learned model is further trained using historic ambient air temperature data for the field accessed from one or more air temperature sensors, and wherein the machine learned model is configured to identify irrigation events based further on ambient air temperature data.

14. The method of claim 8, further comprising measuring one or more ecosystem attributes at least in part by applying one or more ecosystem attribute models to one or more of the detected set of irrigation events.

15. The method of claim 8, further comprising measuring greenhouse gas emissions based at least in part on the detected set of irrigation events.

16. The method of claim 8, further comprising:
accessing historic accelerometer data for one or more time points from one or more accelerometers deployed in the field;
mapping the accelerometer data to the historic temperature measurements corresponding to the one or more time points;
training the machine-learned model based additionally on the mapping of the accelerometer data to the historic temperature measurements;
receiving target accelerometer data from the one or more accelerometers deployed in the field; and
detecting the set of irrigation events by further applying the machine-learned model to the target accelerometer data.

17. A method, comprising:
receiving first temperature data from a first temperature sensor, the first temperature sensor being deployed in a crop field such that the first temperature sensor is affixed above a minimum waterline and below a maximum waterline for the field, the first temperature data including a plurality of temperature readings over a first time period;
reading an ambient air temperature for the first time period; and
identifying one or more irrigation events based at least in part on a comparison of the first temperature data to the ambient air temperature during the first time period.

18. The method of claim 17, wherein comparing the first temperature data to the ambient air temperature comprises:
mapping the first temperature data to the ambient air temperature; and
applying a model to the mapped data, the model configured to identify irrigation events based on the first temperature data and the ambient air temperature.

19. The method of claim 18, wherein the model is a regression model or a machine-learned model.

20. The method of claim 17, wherein the regression model is one of a linear regression, a RANSAC regression, a polynomial regression, a quantile regression, an elastic net regression, a random forest regression, or a gradient boosting regression.

21. The method of claim 17, wherein at least one irrigation event has an associated start time and end time, the method further comprising:
reading a flow rate of water associated with the at least one irrigation event;
determining, from the start time and end time, a total time of pump activity; and
determining, based on the flow rate and the total time of pump activity, a total volume of water for irrigation.

22. The method of claim 17, further comprising:
determining, based on the first temperature data, a dry period for the field; and
aggregating a total dry period for the field over the season.

23. The method of claim 22, where the dry period is determined by a series of temperatures not indicative of the one or more irrigation events.

24. The method of claim 17, wherein reading the ambient air temperature comprises reading second temperature data from a second temperature sensor.

25. The method of claim 17, wherein reading ambient air temperature comprises reading a temperature model constructed by:
generating a time series representing an upper percentile of a second temperature sensor; and
fitting a linear regression to the time series, where the time series of the upper percentile is plotted against a time series of the first temperature sensor.

26. The method of claim 25, wherein a regional temperature model is constructed by generating a time series representing the upper percentile of second temperature data, wherein the second temperature data comprise a plurality of temperature readings from a plurality of temperature sensors over the first time period, wherein the plurality of temperature sensors is deployed in a plurality of crop fields and each of the plurality of temperature sensors is affixed above a minimum waterline and below a maximum waterline, and fitting a linear regression to the time series, where the time series of the upper percentile is plotted against a time series of the first temperature data.

27. The method of claim 17, wherein at least one irrigation event is identified by a presence of a temperature deviation exceeding a minimum period of time and a minimum threshold.

28. The method of claim 17, wherein the first sensor is submerged during at least one irrigation event.

29. The method of claim 17, wherein the first temperature sensor is deployed within a threshold distance of an outlet of a water pump in the field.

30. The method of claim 17, wherein a second temperature sensor is deployed proximate to the first temperature sensor and above the maximum water level.

31. The method of claim 30, wherein the first sensor and the second sensor are placed on a same vertical axis within a threshold distance of an outlet of the water pump, where the first sensor is below the second sensor.

32. The method of claim 31, wherein the first sensor is submerged when the water pump is active, and the second sensor is not submerged when the water pump is active.

33. The method of claim 17, further comprising:
accessing accelerometer data for one or more time points from one or more accelerometers deployed in the crop field;
mapping the accelerometer data corresponding to time points within the first time period to ambient air temperature data; and
identifying one or more irrigation events based additionally on the accelerometer data mapped to the ambient air temperature data.

34. The method of claim 17, further comprising using a set of accelerometer data to identify at least one irrigation event by:
receiving the set of accelerometer data from an accelerometer deployed in the crop field;
processing the set of accelerometer data to identify one or more irrigation events; and
comparing the identified one or more irrigation events from the accelerometer data to the at least one irrigation event determined from the first temperature data.

35. The method of claim 34, wherein the set of accelerometer data and the first temperature data are associated with a same water pump.

36. The method of claim 35, further comprising generating a time series of irrigation events wherein each irrigation event was identified from both the accelerometer data and the first temperature data.

37. The method of claim 35, further comprising generating a time series of irrigation events wherein each irrigation event was identified from at least one of the accelerometer data or the first temperature data.

38. The method of claim 34, wherein the first temperature sensor and accelerometer are attached to the same substrate.

39. The method of claim 38, where the substrate comprises a flexible region located between a portion of the substrate that is anchored and a vibration sensor.

40. The method of claim 17, wherein at least one irrigation event during the first time period is a time series of daily irrigation activity.

41. The method of claim 17, wherein a water volume is estimated by a duration of a period in which a pump is turned on at a known flow rate of water through the pump.

42. The method of claim 41, wherein a field level water balance model is applied to the time series of daily irrigation activity.

43. The method of claim 17, further comprising:
initiating an irrigation event based on the identified irrigation events.

44. The method of claim 43, wherein the irrigation event is initiated in response to determining that the identified irrigation events are not sufficient to irrigate the crop field.

45. The method of claim 17, further comprising:
modifying a planned irrigation event based on the identified irrigation events.

46. The method of claim 45, wherein modifying the planned irrigation event comprises at least one of: increasing a length of the planned irrigation event, reducing the length of the planned irrigation event, increasing a flow of the planned irrigation event, decreasing the flow of the planned irrigation event, modifying a start time of the planned irrigation event, modifying an end time of the planned irrigation event, and canceling the planned irrigation event.

46. The method of claim 45, wherein the planned irrigation event is modified in response to determining that the planned irrigation event is likely to cause one or more ecosystem attributes of the crop field to exceed a predefined threshold.

47. The method of claim 46, wherein the predefined threshold is a threshold quantity of greenhouse gas emissions.

48. The method of claim 17, further comprising measuring one or more ecosystem attributes at least in part by applying one or more ecosystem attribute models to one or more identified irrigation events

49. The method of claim 17, wherein the ambient air temperature is determined by accessing ambient air temperature data from a set of sensors located at one or more locations within a threshold proximity to the crop field and combining the accessed ambient air temperature data.
